(19) United States
(12) Patent Application Publication
(10) Pub. No.: US 2016/0109650 A1
(43) Pub. Date: Apr. 21, 2016

(54) OPTICAL FIBER FOR FIBER BRAGG GRATING

(71) Applicant: SUMITOMO ELECTRIC INDUSTRIES, LTD., Osaka (JP)

(72) Inventors: Takuji NAGASHIMA, Yokohama-shi (JP); Shigehiro NAGANO, Yokohama-shi (JP)

(21) Appl. No.: 14/877,167

(22) Filed: Oct. 7, 2015

(30) Foreign Application Priority Data
Oct. 16, 2014 (JP) 2014-211378
Jul. 17, 2015 (JP) 2015-142847

(51) Int. Cl. G02B 6/02; G02B 6/036

(52) U.S. Cl. CPC G02B 6/02114; G02B 6/03627

(57) ABSTRACT

An optical fiber having a composition that is most suitable from the viewpoint of filter formation time and filter properties of slanted fiber grating (SFG) is provided. An optical fiber made of silica-based glass comprises a core region, which does not contain GeO₂ and includes the optical axis, and a cladding region formed around the core region. The cladding region has a refractive index smaller than that of the core region and contains GeO₂ of 6.8 wt % or more. SFG made with the optical fiber enables base loss of 2 dB or less, peak wavelength shift of 1.2 nm or less, and change of 0.2 nm or less in width at half maximum.

### FIELD OF THE INVENTION

The present invention relates to an optical fiber suitable for fiber Bragg grating.

### BACKGROUND ART

International Publication No. 2003/093887 (Patent Document 1) discloses an optical fiber Bragg grating having a refractive-index modulation in a predetermined range along the optical axis of an optical fiber, and an optical fiber suitable for forming such refractive-index modulation. The optical fiber Bragg grating disclosed in Patent Document 1 is a slanted fiber grating (SFG), in which the periodic length of refractive-index modulation is several hundred nanometers, and the lattice plane of the grating is inclined relative to a section perpendicular to the optical axis of the optical fiber. Such SFG is applied as a gain equalization filter for flattening the gain spectrum of an erbium-doped fiber amplifier (EDFA), for example.

The optical fiber disclosed in Patent Document 1 is made of silica-based glass and comprises a core region including the center of an optical axis and a cladding region formed around the core region, whereas the core region does not contain GeO₂, and the cladding region contains GeO₂ at least at its part. The silica glass doped with GeO₂ has photosensitivity to light having a predetermined wavelength (for example, ultraviolet light having a wavelength of 270 nm or less), and the refractive index thereof increases when it is irradiated with such light. Utilizing such phenomenon makes it possible to form a refractive-index modulation in the silica glass doped with GeO₂. The composition of an optical fiber which is the most suitable from the viewpoint of both process time for filter formation and filter properties (base loss, peak wavelength shift, and change of width at half maximum in a transmission spectrum due to refractive-index modulation) is unknown, since Patent Document 1 does not disclose it. Here, the “base loss” means a transmission loss that is not influenced by refractive-index modulation, and the “peak wavelength” means a wavelength at which the transmittance becomes minimum with the refractive-index modulation.

### SUMMARY OF THE INVENTION

### Technical Problem to be Solved by the Invention

An object of the present invention is to provide an optical fiber having a composition that is optimal from the viewpoint of filter properties of SFG and filter formation time.

### Solution to the Problem

An optical fiber of the first embodiment of the present invention, which is made of silica-based glass, comprises a core region including an optical axis of the fiber and a cladding region formed around the core region, whereas the cladding region has a refractive index smaller than a refractive index of the core region and contains GeO₂ having a concentration of 6.8 wt % or more at least at a part of the cladding.

In the optical fiber of the first embodiment, the concentration may be 7.4% or less or 8.7% or less. The part of the cladding region may have an outer diameter that is 1.5 to 4.0 times larger than a mode field diameter at a wavelength in the C-band. Here, the “C-Band” spreads from 1530 nm to 1565 nm.

The optical fiber of the second embodiment of the present invention is an optical fiber made of silica-based glass and comprises a core region including an optical axis of the fiber and a cladding region formed around the core region, whereas the cladding region has a refractive index smaller than a refractive index of the core region and contains GeO₂ having a concentration of 7.4 wt % or more and 7.9 wt % or less, or not less than 7.4 wt % and not more than 8.7 wt % at least at a part thereof, the part of the cladding region has an outer diameter that is 1.5 to 4.0 times larger than a mode field diameter at a wavelength in the C-band.

In the optical fiber of both embodiments, the part of the cladding region may include an inner circumference and an outer circumference around the inner circumference. The concentration of GeO₂ at the inner circumference is larger than the concentration of GeO₂ at the outer circumference, and the difference between the GeO₂ concentration at the inner circumference and the GeO₂ concentration at the outer circumference is 0.2 wt % or more. The above-mentioned core region does not need to contain GeO₂.

### Advantageous Effects of Invention

According to the present invention, it is possible to offer an optical fiber which has an optimal composition from the viewpoint of filter formation time and filter properties of SFG.

### BRIEF DESCRIPTION OF DRAWINGS

FIG. 1 is a schematic diagram showing a section of an optical fiber according to the embodiment of the present invention.

FIG. 2 is a schematic diagram showing an example of refractive-index profile in the radial direction of the optical fiber of FIG. 1.

FIG. 3 is a graph showing an example of transmission spectrum of SFG.

FIG. 4 is a graph showing an example of change with respect to the transmission spectrum of SFG when the amount of ultraviolet light irradiated to the optical cladding region of the optical fiber of FIG. 1 is varied.

FIG. 5 is a graph explaining a residual ratio in the case of filter formation.

FIG. 6 is a graph showing relations between GeO₂ concentration in an optical cladding region and the base loss of a SFG when a notch depth in the filter spectrum is 10 dB.

FIG. 7 is a graph showing relations between GeO₂ concentration in an optical cladding region and sensitivity of WHM on a notch depth in the filter spectrum of a SFG.

FIG. 8 is a graph showing relations between GeO₂ concentration in an optical cladding region and the amount of peak wavelength shift in the filter spectrum of a SFG.

FIG. 9 is a graph showing relations between GeO₂ concentration in an optical cladding region and residual ratio.

FIG. 10 is a table which shows specifications of optical fibers according to the embodiment.

### DESCRIPTION OF EMBODIMENTS

Hereafter, with reference to accompanying drawings, detailed explanation of preferred embodiments for carrying out the present invention will be given. In the explanation of drawings, the same mark is given to identical elements and the overlapping explanation is omitted. The present invention is not limited to these embodiments, and it is intended that the scope of the invention be understood by the claims and equivalents, including all modifications thereto.

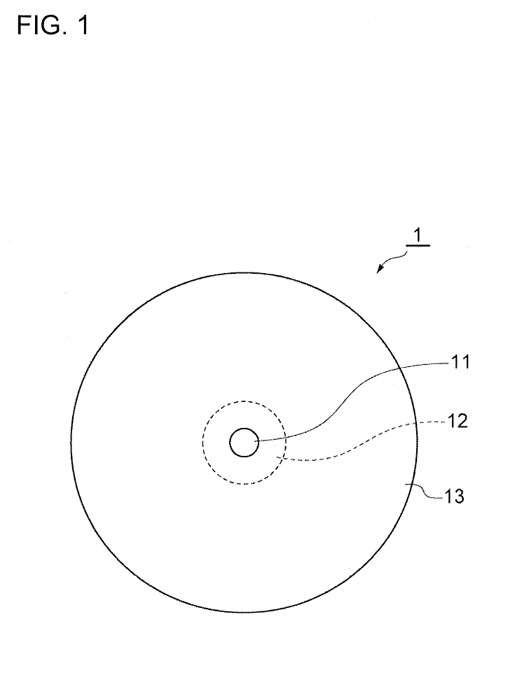

FIG. 1 is a schematic diagram showing a cross-section of an optical fiber 1 according to an embodiment of the present invention. The optical fiber 1, which is made of silica-based glass, comprises a core region 11 including the optical axis center, an optical cladding region 12 provided around the core region 11, and a jacket region 13 provided around the optical cladding region 12. The core region 11, which may contain Cl and does not contain GeO₂, does not have photosensitivity to ultraviolet light. The optical cladding region 12, which contains GeO₂ and fluorine, has photosensitivity. The jacket region 13, which may contain fluorine, does not have photosensitivity.

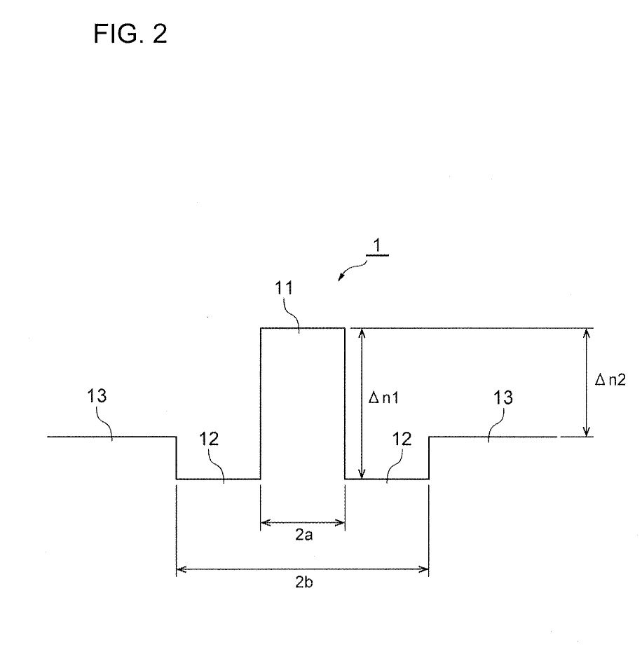

FIG. 2 is a schematic diagram showing an example of refractive-index profile in the radial direction of the optical fiber 1. The refractive index of the optical cladding region 12 is smaller than the refractive index of the core region 11. The refractive index of the jacket region 13 is smaller than that of the core region 11 and larger than that of the optical cladding region 12. The relative refractive index difference Δn1 of the optical cladding region 12 with respect to the core region 11 is −0.33% to −0.45%. The relative refractive index difference Δn2 of the jacket region 13 is about −0.35% with respect to the core region 11. The outer diameter 2a of the core region 11 is about 9 μm. The outer diameter 2b of the optical cladding region is about 30 μm.

In the optical fiber 1, the optical cladding region 12 is a photosensitive region which has photosensitivity to light having a predetermined wavelength in the ultraviolet region, and the refractive index of the optical cladding region is made larger by irradiation of the ultraviolet light. The core region 11 and the jacket region 13 do not have photosensitivity. By irradiating the optical fiber 1 with light which has a predetermined wavelength in the ultraviolet region and in which the intensity is spatially modulated, a refractive-index can be modulated in a predetermined range in the optical cladding region 12 along the direction of the optical axis of the optical fiber 1, whereby SFG can be formed. Of light guided through the core region 11, light having a specific wavelength in the operating window which satisfies Bragg condition can be leaked to the optical cladding region 12, so that a SFG can function as a filter having a specific loss as a function of wavelength. By changing the periodic length of refractive index modulation, the filtering properties of SFG can be changed. It is possible to obtain arbitrary filter properties by changing the periodic length of refractive index modulation in the direction of the optical axis of an optical fiber.

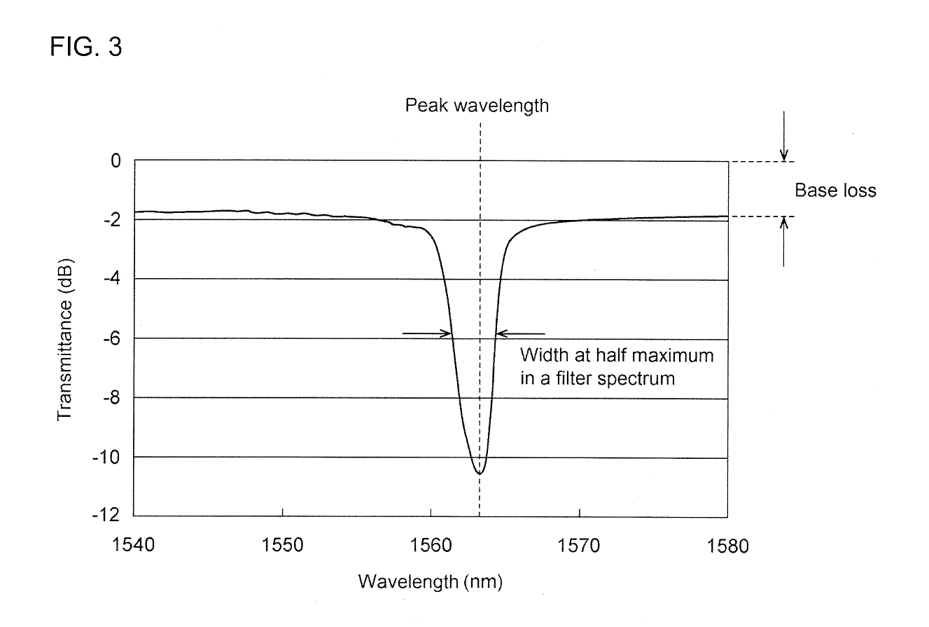

FIG. 3 is a graph showing an example of transmission spectrum of SFG. The transmission spectrum is characterized by filter properties (base loss, which is not due to refractive index modulation; peak wavelength, at which the transmittance becomes minimum due to the refractive index modulation; and width at half maximum in a transmission spectrum due to refractive index modulation). In order to produce SFG at high yield, it is necessary to control the filter properties. Since the optical cladding region 12 of the optical fiber 1 contains GeO₂ of 6.8 wt % or more, SFG made by using the optical fiber 1 can be such that the base loss is 2 dB or less, the peak wavelength shift is 1.2 nm or less, and the change of width at half maximum (WHM) in the transmission spectrum is 0.2 nm or less. If the concentration of GeO₂ is 7.4 wt % or more, SFG can be made at a higher yield.

The photosensitive region may include an inner circumference and an outer circumference around the inner circumference. The concentration of GeO₂ at the inner circumference is larger than that at the outer circumference. In such case, it is possible to obtain satisfactory characteristics for the base loss, the peak wavelength shift, and the change of width at half maximum in a transmission spectrum. Also, by decreasing the GeO₂ concentration of the outermost layer in the photosensitive region, the generation of voids at the interface between the cladding region and the jacket region can be suppressed, whereby the yield can be improved.

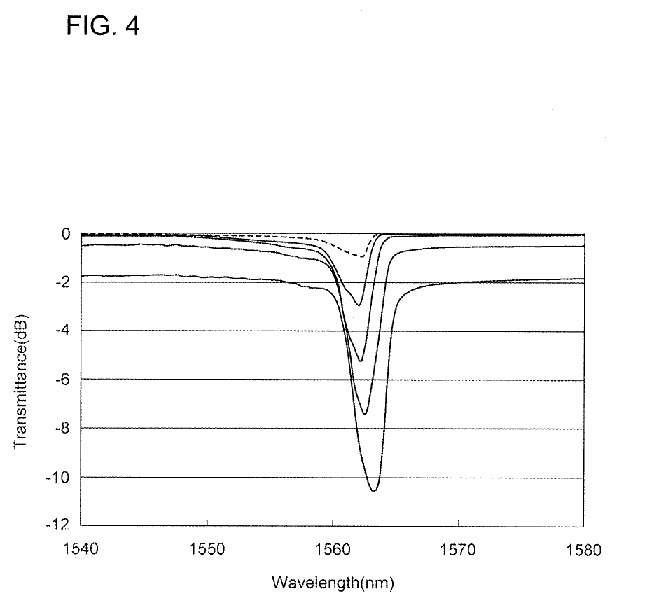

FIG. 4 is a graph showing an example of change with respect to the transmission spectrum of SFG when the amount of ultraviolet light irradiated to the optical cladding region of the optical fiber of FIG. 1 is changed. As the amount of irradiated ultraviolet light becomes large, the loss at the peak wavelength of the transmission spectrum of SFG increases. Moreover, the base loss becomes the larger, the peak wavelength becomes the longer, and the width at half maximum becomes the wider.

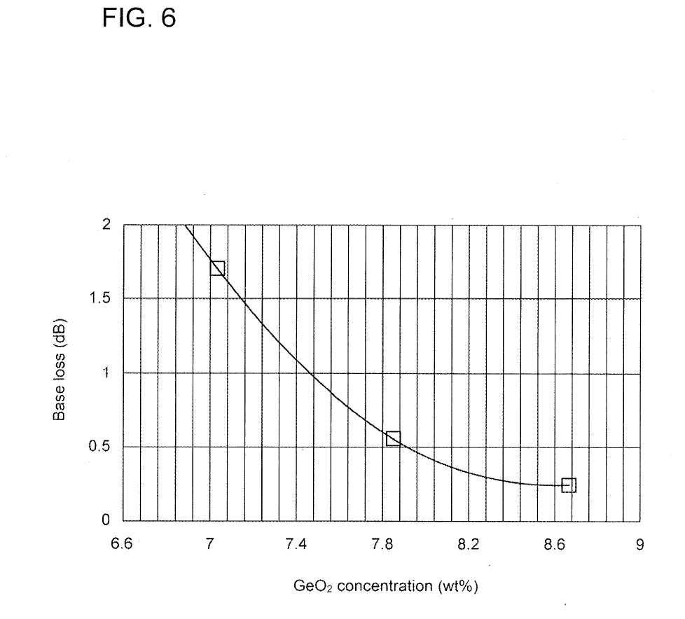

FIG. 6 is a graph showing relations between the base loss of a SFG and GeO₂ concentration in an optical cladding region 12. As the GeO₂ concentration in the optical cladding region 12 increases, the base loss of SFG decreases. The base loss is preferably 2 dB or less, and more preferably 1 dB or less.

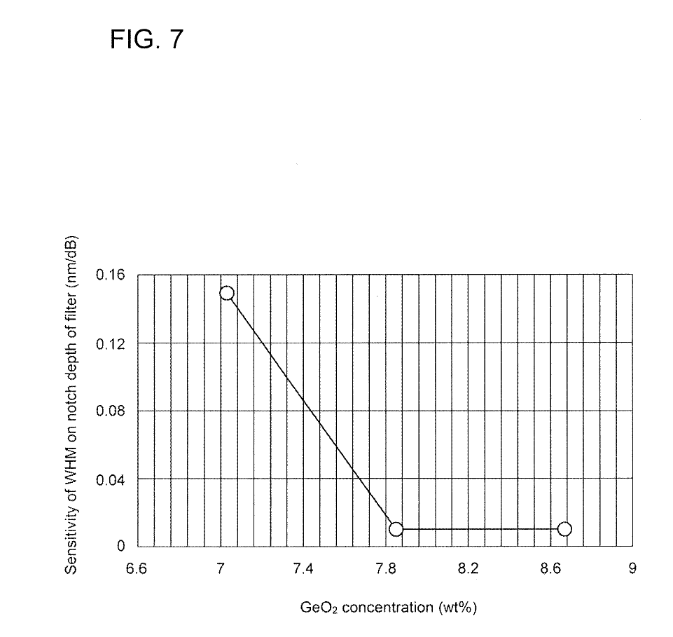

FIG. 7 is a graph showing relations between GeO₂ concentration in an optical cladding region and sensitivity of width at half maximum on notch depth in the filter spectrum of SFG. As GeO₂ concentration in the optical cladding region 12 increases, the filter notch depth (transmittance) dependence of width at half maximum in the filter spectrum of SFG decreases. The change of width at half maximum in the filter spectrum is preferably 0.2 nm/dB or less, more preferably 0.08 nm/dB or less.

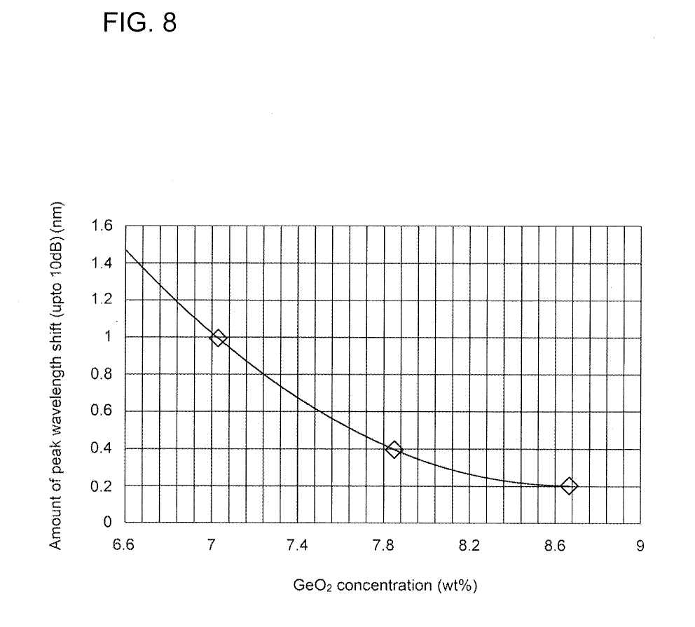

FIG. 8 is a graph showing relations between GeO₂ concentration in an optical cladding region and the amount of peak wavelength shift of a SFG. If the peak loss becomes larger, the wavelength at the peak loss may change. As the GeO₂ concentration in the optical cladding region 12 increases, amount of shift of the peak wavelength of SFG decreases. It is preferable that the amount of peak wavelength shift is 1.2 nm (shift amount up to the transmittance of 10 dB) or less, and more preferably 0.6 nm or less.

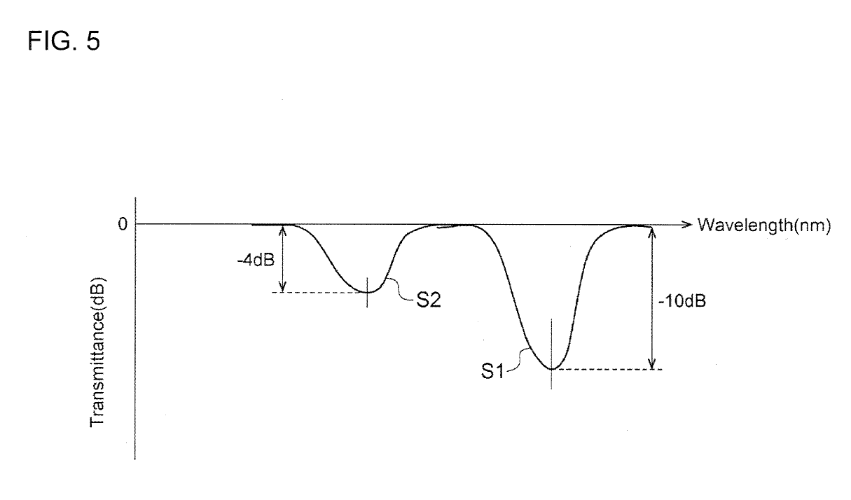

To secure the long-term reliability of SFG, it is preferable to carry out an annealing treatment upon manufactured SFG. However, filter properties may be changed by the annealing treatment. FIG. 5 is a graph explaining a residual ratio at the time of annealing. FIG. 5 shows a transmission spectrum S1 before an annealing treatment and a transmission spectrum S2 after the annealing treatment. By the annealing treatment, the transmittance is increased (namely, the loss is decreased), and the peak wavelength is shifted to shorter. The residual ratio is defined as a ratio of the filter loss after the annealing treatment to the filter loss before annealing treatment. In the example shown in FIG. 5, the residual ratio is 40%.

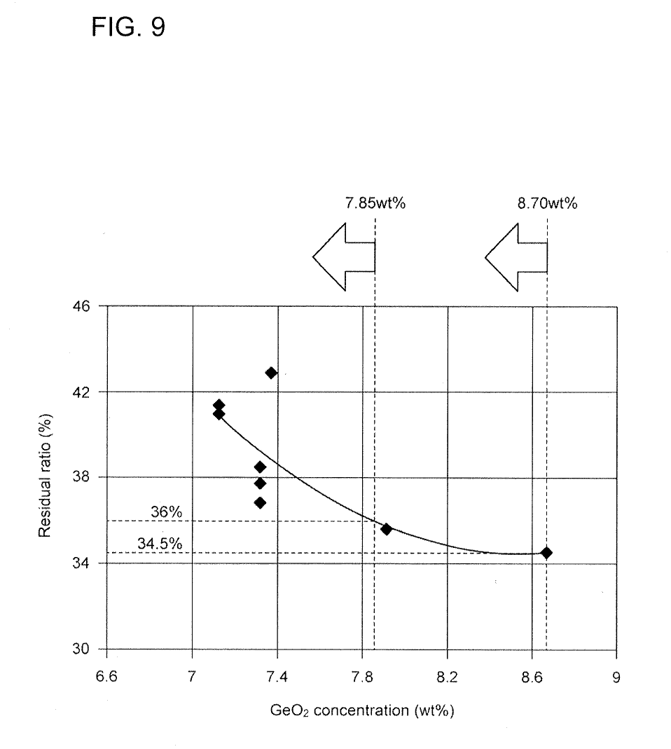

FIG. 9 is a graph showing relations between GeO₂ concentration in an optical cladding region 12 and residual ratio. As the GeO₂ concentration in the optical cladding region 12 decreases, the residual ratio increases. To obtain a residual ratio of 36% or more, the GeO₂ concentration in the optical cladding region 12 should be made 7.85 w % (about 7.9 w %) or less. If the GeO₂ concentration in the optical cladding region 12 is made 8.7 wt % or less, the residual ratio can be made 34.5% or more. If the GeO₂ concentration in the optical cladding region 12 is made 7.4 wt % or less, the residual ratio can be made 38% or more.

The annealing treatment will degrade the filtering function. Therefore, the filter spectrum should be made as one having the higher loss beforehand. As the residual ratio increases, the control of filter properties which change as the time of annealing becomes easier. Also, the initial loss in filter spectrum can be made lower. As a result, the manufacturing time can be shortened. The residual ratio is preferably 36% or more. However, even if the GeO₂ concentration is increased, the residual ratio tends to gradually approach to about 34%. If the GeO₂ concentration is 8.7 wt % or less, writing properties and yield will be superior to the case of 7.85 wt % of GeO₂ concentration as well as the residual ratio of 34% or more can be maintained. Thus, the GeO₂ concentration of 8.7 wt % or less also is suitable.

As shown in FIGS. 6 to 9, as the GeO₂ concentration in the optical cladding region 12 increases, the filter notch depth dependence of width at half maximum in the filter spectrum decreases, as well as the base loss of SFG. In addition, as the GeO₂ concentration increases, the shift amount of the peak wavelength decreases, as well as the residual ratio. As to the filter properties (the base loss, the filter depth dependence of width at half maximum in the filter spectrum, and the shift amount of the peak wavelength) of SFG, larger GeO₂ concentration is preferable. On the other hand, as to the residual ratio, smaller GeO₂ concentration is more desirable. Thus, improving the filter properties of SFG and shortening the manufacturing time for SFG are mutually in a trade-off relationship with respect to the GeO₂ concentration in the optical cladding region 12.

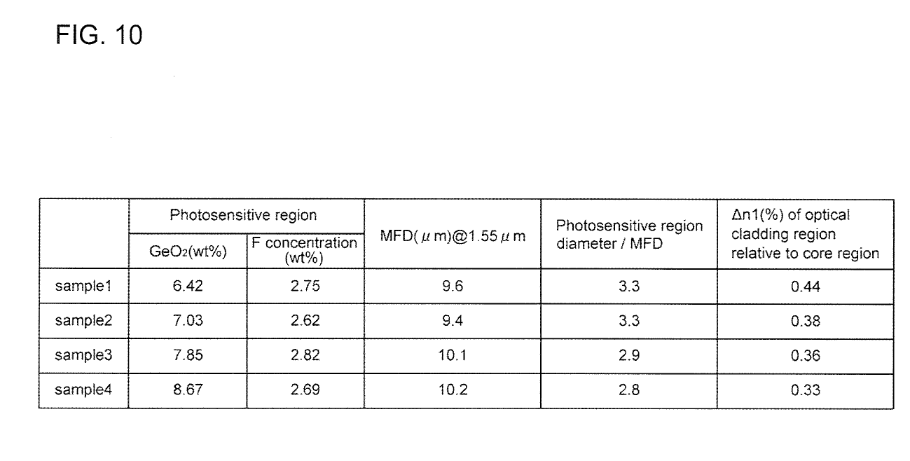

In the table of FIG. 10, the specifications of optical fibers, samples 1 to 4, according to the embodiment are shown, including: GeO₂ concentration and fluorine concentration in each optical cladding region (photosensitive region); mode field diameter (MFD) at the wavelength of 1.55 μm; ratio of outer diameter 2b of optical cladding region to MFD; and relative refractive index difference Δn1 of optical cladding region with respect to core region.

The following is an explanation about the outer diameter 2b of an optical cladding region (photosensitive region). When the outer diameter 2b of an optical cladding region is too small, the overlap of the optical cladding region and the electromagnetic field of propagating lightwave guided through the core becomes smaller, resulting in degradation of filter properties. When the outer diameter 2b of an optical cladding region is too large, the silica glass doped with Ge and fluorine tends to generate voids by heating. Therefore, the larger the outer diameter 2b, the less the yield of a fiber becomes, although it does not affect filter properties. The lower limit of the outer diameter 2b of the optical cladding region is preferably 1.5 or more times larger than the MFD at a wavelength in the operating wavelength in view of the electromagnetic field of the propagation lightwave guided through the core. The upper limit of the outer diameter 2b of the optical cladding region is preferably 4.0 or less times larger than the MFD. By forming the outer diameter of an optical cladding region so as to be 1.5 to 4.0 times larger than the mode field diameter in an operating wavelength band, it is made possible to manufacture an optical fiber Bragg grating at high yield, while the degradation of filter properties can be small.

What is claimed is:

1. An optical fiber made of silica-based glass, comprising:
a core region including an optical axis of the fiber and
a cladding region formed around the core region, the cladding region having a refractive index smaller than a refractive index of the core region and containing GeO₂ having a concentration of 6.8 wt % or more at least at a part thereof.

2. An optical fiber according to claim 1, wherein
the concentration is 7.4% or less.

3. An optical fiber according to claim 1, wherein
the concentration is 8.7% or less.

4. An optical fiber according to claim 2, wherein
said part of the cladding region has an outer diameter, the outer diameter being 1.5 to 4.0 times larger than a mode field diameter at a wavelength in the C-band.

5. An optical fiber according to claim 3, wherein
said part of the cladding region has an outer diameter, the outer diameter being 1.5 to 4.0 times larger than a mode field diameter at a wavelength in the C-band.

6. An optical fiber according to claim 1, wherein
said part of the cladding region includes an inner circumference and an outer circumference around the inner circumference, the concentration of GeO₂ at the inner circumference is larger than the concentration of GeO₂ at the outer circumference, and the difference between the GeO₂ concentration at the inner circumference and the GeO₂ concentration at the outer circumference is 0.2 wt % or more.

7. An optical fiber according to claim 1, wherein
the core region does not contain GeO₂.

8. An optical fiber made of silica-based glass, comprising:
a core region including an optical axis of the fiber and
a cladding region formed around the core region, the cladding region having a refractive index smaller than a refractive index of the core region and containing GeO₂ having a concentration of 7.4 wt % or more and 8.7 wt % or less at least at a part thereof, said part having an outer diameter, the outer diameter being 1.5 to 4.0 times larger than a mode field diameter at a wavelength in the C-band.

9. An optical fiber according to claim 8, wherein
the concentration is 7.9 wt % or less.

10. An optical fiber according to claim 8, wherein
said part of the cladding region includes an inner circumference and an outer circumference around the inner circumference, the concentration of GeO₂ at the inner circumference is larger than the concentration of GeO₂ at the outer circumference, and the difference between the GeO₂ concentration at the inner circumference and the GeO₂ concentration at the outer circumference is 0.2 wt % or more.

11. An optical fiber according to claim 8, wherein
the core region does not contain GeO₂.
